(19) United States
(12) Patent Application Publication
(10) Pub. No.: US 2005/0084839 A1
(43) Pub. Date: Apr. 21, 2005

(54) Method for selecting oocytes by using a response to LPA stimulation

(75) Inventors: Tomoko Takeshita, Kawagoe (JP); Takako Mizoguchi, Sayama (JP); Shuhei Hashiba, Wako (JP); Jun Otomo, Tokyo (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/876,551

(22) Filed: Jun. 28, 2004

(30) Foreign Application Priority Data
Oct. 16, 2003 (JP) 2003-356812

(51) Int. Cl. A01N 1/02

(52) U.S. Cl. 435/2; 800/21

(57) ABSTRACT

The selection of oocytes has largely relied on manual procedures, resulting in their lack of uniformity. Groups of oocytes are prepared and sorted, the current responses of these groups of oocytes upon exposure to lysophosphatidic acid (LPA) are measured, the response of G protein-coupled receptor (GPCR) is determined for each group of oocytes, and desirable groups of oocytes are selected on the basis of the response of GPCR. In this way, oocytes having a uniformly high response of GPCR can be selected.

### CLAIM OF PRIORITY

The present application claims priority from Japanese application JP 2003-356812 filed on Oct. 16, 2003, the content of which is hereby incorporated by reference into this application.

### FIELD OF THE INVENTION

The present invention relates to oocytes suitable for detection of response of G protein-coupled receptor and a method for selecting oocytes.

### BACKGROUND OF THE INVENTION

Xenopus laevis oocytes are used widely for injection of a test sample such as a gene, dye, protein, peptide or drug and subsequent confirmation of their actions, analysis of gene functions, production of proteins as gene products, and the like as disclosed in JP-A No. 65240/2002. In particular, a method in which a G protein-coupled receptor (GPCR) is overexpressed in the oocytes and its response to external stimuli such as drugs is detected is in wide use because microinjection of a gene into the oocytes and measurement of their membrane potential are relatively easy to be carried out. In this methodology, it is desirable that the response of GPCR is not only as uniform as possible among individual oocytes but also high in its sensitivity. In other words, when agents are screened using a certain response level of GPCR as a threshold, it is desirable that a population of the oocytes uniform in the sensitivity are used. However, the oocytes extracted from the mother bodies are not necessarily uniform in the response of GPCR. The most likely cause may seem to be genetic factors inherited from the parents. There is an individual difference in character even among the same strain of animals, and the response of GPCR is also not an exception to this fact.

Accordingly, it is necessary to select oocytes used in practical experiments in advance of carrying but the experiments. The conventional standard for this selection was primarily based on the appearances of oocytes or eggs. Namely, the judgment was made by the size, shape, color, pattern and the like of the cells based on manual procedures under a microscope.

It has been reported in “The Journal of Biological Chemistry”, 276, 15208-15215 (2001) that the receptor of LPA1 was expressed in oocytes and subsequently cloned. However, nothing is described about their selection.

[Patent Literature 1] JP-A No. 65240/2002 (P2002-65240A)(43) (Mar. 5, 2002) laid open.

(Non-patent Literature 1] Kimura, Y. et al., “The Journal of Biological Chemistry”, Vol. 276, pp. 15208-15215 (2001).

The selection based on the appearance as described above depends largely on the skill, subjective judgment, and the like of the performer, giving rise to a problem that the quality of selected oocytes varies. The selection based on the appearance does not necessarily reflect the response of GPCR, and therefore is not necessarily suitable for screening of agents that exert an influence upon GPCR-induced signaling after a GPCR was overexpressed in the selected oocytes.

In other words, a method for selecting oocytes or eggs that are suitable for detection of response of GPCR is required.

### SUMMARY OF THE INVENTION

The present invention provides not only a method for reducing non-uniformity of response of GPCR in oocytes arising from individual difference in their mother bodies and for selecting oocytes with a higher response of GPCR but also those oocytes with a higher response of GPCR that are obtained by the selection.

This invention is based on the fact that lysophosphatidic acid receptor (LPA), a kind of GPCR, is expressed endogenously in the oocytes. Specifically, the method used in this invention is as follows: A portion of a group of oocytes (preferably 4 to 10 cells) extracted from a mother body are stimulated by LPA and the current response to the LPA stimulation is measured for each cell. An average of the responses is determined for a brood of oocytes from a mother, that is, a group of oocytes. Thus, groups of oocytes having an average value larger than a certain level or within a certain range are selected and the oocytes belonging to these groups are used for further experiments. The response of GPCR in oocytes is tested for every group of oocytes, by which the oocytes showing the response of GPCR that is not genetically suitable for experiments are excluded, and phenotypically preferred oocytes are selected. Only the oocytes that belong to a group of oocytes chosen by this selection may be used in a test to detect the response of GPCR (including screening for agonists and antagonists of GPCR) and the like.

Lysophosphatidic acid (LPA) is one of phospholipids that has an action similar to hormones or growth factors, acts on a variety of cells and tissues, and regulates the growth and differentiation of these cells. Such effects are brought about via LPA receptor (LPAR). LPAR is a kind of GPCRs. When LPAR is activated by LPA, the former then activates a G protein, inducing an activation of the phosphatidylinositol turnover. Approximately 2,000 GPCRs have been found and these form a family of G protein-coupled receptors. The activation pathway of the phosphatidylinositol turnover is governed by a mechanism common to all GPCR signaling and the intensity of activation of the phosphatidylinositol turnover may be measured by a current response induced by the activation.

Thus, when the intensity is high, i.e., the current response is high, it may be inferred that responses of GPCRs other than LPAR are also high. Through the use of this property, the current response to LPA is measured in advance and only those oocytes having a response higher than a certain level or within a certain range are used at the time of screening of molecules that exert an effect on GPCR signaling (including agonists and antagonists of GPCR) and the like.

Here, the present invention is more specifically explained with reference to FIG. 1. First, ovaries are taken out from each frog A, B, or C, respectively, and a group of oocytes are pre-selected and sorted for each frog by their appearances and resting membrane potentials. Then, a portion of the oocytes are randomly extracted for each frog A, B, or C, respectively, and the oocytes derived from each mother body are stimulated by LPA, respectively. The oocytes from a frog that show a high response to LPA stimulation (a high current response) are subjected to further experiments. For example, when the current response in frog B was higher compared with those in frogs A and C as the result of LPA stimulation, the oocytes belonging to the group of oocytes from frog B are subjected to further experiments. It should be noted that oocytes from the same mother body exhibit a narrow range of variation in current response, and therefore, the LPA stimulation may be performed with several oocytes extracted at random.

Note that the oocytes once stimulated by LPA should be treated as spent and the untreated oocytes from the same mother body should be subjected to further experiments.

A specific GPCR that corresponds to an experimental objective may also be overexpressed in oocytes in advance of the measurement of current response to LPA stimulation.

More explanation is as follows:

In the present specification and in the scope of claims of the present application, “a group of oocytes” refers to a population of a brood of oocytes derived from a mother body. “Current response to LPA stimulation” refers to the intensity of current response brought about by the activation of signal transduction that is induced by stimulation of LPAR by LPA, and “response of GPCR in oocytes” can be regarded as a response to stimulation of GPCR that may be inferred from the current response to LPA stimulation. High response of GPCR means high current response to LPA stimulation, and in the present invention, the current response means a value that can be determined by the measurement of current response to LPA stimulation of LPAR expressed endogenously in Xenopus laevis oocytes. This is based on the fact that LPAR is a kind of GPCR and that receptors belonging to the GPCR superfamily all share a common downstream pathway in the signal transduction.

In the present procedures, a portion of oocytes (preferably 4 to 10 cells) extracted at random from a group or a brood of oocytes from a mother body are stimulated by LPA and the current response to LPA stimulation is measured. Then, an average of the current responses is determined for the oocytes derived from a group of oocytes. Among groups of oocytes, the oocytes belonging to a group of oocytes that show a relatively high average value (i.e., response of GPCR) or a value higher than a certain value or within a certain range are used for further experiments. A value higher than a certain value may be equal to or higher than 0.5 μA, 0.6 μA, 0.7 μA, 0.8 μA, 0.9 μA, or 1.0 μA, respectively. A value within a certain range may be a value in the range between 0.5 and 3.0 μA, 0.6 and 3.0 μA, 0.7 and 3.0 μA, 0.8 and 3.0 μA, or 0.8 and 2.5 μA, respectively. It should be noted that the value higher than a certain value and the value within a certain range may be appropriately set depending on the working purpose and the like by an engineer who carries out the present invention and may be an arbitrary value. For example, when a group of oocytes with high quality are required to obtain in view of the nature of screening, a group of oocytes having a high current response to LPA stimulation may be selected and the above range may be set to a range of higher values. A maker to produce groups of oocytes may conceive various ways of selling depending on user's purposes, for example, setting the price of high quality set higher by collecting groups of oocytes high in the current response and setting the price lower for groups of oocytes high in the current response but wide in the range. Since responses of GPCR of oocytes are tested for each mother body (i.e., each group of oocytes derived from the same mother body), the oocytes showing a response of GPCR that is not genetically suitable for experiments are excluded, and the oocytes that are genetically excellent in response of GPCR can be selected.

Accordingly, the present invention provides the method for selecting oocytes excellent in response of GPCR using the current response to LPA stimulation as an indicator, the method for detecting a response of GPCR in oocytes that includes the selection of oocytes excellent in response of GPCR using the current response to LPA stimulation as the indicator, the method for screening of agonists or antagonists of GPCRs, and the oocytes excellent in response of GPCR selected by said methods.

Here, “excellent in response of G protein-coupled receptor (GPCR)” means that the difference between the peak current value before LPA stimulation and the peak current value after LPA stimulation in the oocytes belonging to the same group of oocytes or an average value of the differences in a group of oocytes is higher compared with that in other groups of oocytes, equal to or higher than a certain value, or within a value range as described above. Those oocytes are advantageous for use in experiments that involve the detection of response of GPCR to stimulation.

The groups of oocytes selected in this way or the oocytes belonging to the groups are suitable for various experiments and are included in the present invention.

The oocytes belonging to the groups of oocytes selected by the above methods can be used in screening for agonists or antagonists of GPCR. It is very worthwhile to use the oocytes belonging to the groups of oocytes that show response to LPA higher than a certain level or within a certain range according to the selection and are judged to be excellent in response of GPCR. The reason is that having response to LPA higher than a certain level or within a certain range implies having sensitivity to activation of phosphatidylinositol turnover higher than a certain level or within a certain range, and therefore, the use of the oocytes belonging to such groups of oocytes allows screening with only those oocytes in uniform genetic character. Screening for agonists or antagonists of a specific GPCR is conventionally performed using the current response to stimulation of the specific GPCR as an indicator. In many cases, the response of GPCR varies, however, among individual cells, particularly due to their genetic characters. The use of the oocytes belonging to a group of oocytes that have the same genetic character and are found to have appropriate responses of GPCR by a preliminary measurement of the response to LPA may reduce the variation in the current response of GPCR resulting from the genetic character of oocytes. Accordingly, the use of the oocytes thus obtained in the screening described above may enhance the reliability of data.

For the purpose of screening for agonists or antagonists of GPCRs with oocytes, the specific target GPCR must be expressed in oocytes, which is usually carried out by microinjection of mRNA, cRNA or expressible form of nucleotides encoding the target GPCR. Screening is then performed with the oocytes that expressed the GPCR on the cell membrane.

GPCRs to be overexpressed here may originate from any animals. The target GPCR may be any one of those belonging to known GPCR superfamily, and the nucleotide sequence encoding the GPCR may be obtained by retrieving various publications or database. “G protein-coupled receptor (GPCR)” used in the present specification means a protein that exists on the cell membrane when overexpressed in oocytes and induces an activation of phosphatidylinositol turnover via the activation of a G protein by stimulation with a ligand from the outside of cells. The GPCR may be a native form of cloned GPCR or its appropriately engineered form according to each experimental purpose. Examples of the engineering may include deletion, substitution, and addition of amino acid residues in such a way as not to lose completely the inducibility of activating the phosphatidylinositol turnover. In this context, a chimera protein in which the extracellular domain derived from a certain receptor (including receptors other than GPCRs) and the intracellular domain of a known GPCR are linked together by genetic engineering technology (the transmembrane domain may originate from either receptor) is also known, in certain cases, to be capable of inducing the activation of phosphatidylinositol turnover by extracellular stimulation with a ligand corresponding to the receptor from which the extracellular domain originates, via an activation of the intracellular domain, and such chimera proteins are also included in GPCRs.

In another embodiment, oocytes suitable for experiments may be selected by the above methods using the response to LPA as an indicator after a specific GPCR has been overexpressed.

The oocytes showing a high response of GPCR in the measurement of response to LPA stimulation may be considered to have a high biological activity as well, and therefore, the oocytes belonging to the groups of oocytes selected by the above selection are useful for all subsequent experiments (including screening of compounds).

According to the present invention, the oocytes having response of GPCR higher than a certain level or within a certain range can be used in the experiments with oocytes where GPCR signaling is used as an indicator. Thus, accuracy and reliability may be enhanced in the experiments that are carried out using the response of GPCR as an indicator, particularly, in screening for agonists and antagonists of GPCRs and the like.

### BRIEF DESCRIPTION OF THE DRAWINGS

FIG. 1 is a conceptual drawing of the present invention;

FIG. 2 is a graphic representation of Table 1 where error bars show the standard deviation of the data obtained from individual cells in each batch;

FIG. 3 is a diagram of an apparatus for microinjection and current response measurement of the present invention;

FIG. 4 is a conceptual drawing of screening for agonists of histamine receptor where FIG. 4A represents an agonistic response and FIG. 4B represents a non-agonistic response;

FIG. 5A is a conceptual drawing of screening for antagonists of histamine receptor and represents a non-antagonistic response; and

FIG. 5B is a conceptual drawing of screening for antagonists of histamine receptor and represents an antagonistic response.

### DETAILED DESCRIPTION OF THE INVENTION

The present invention is explained below in detail.

First, an ovary is extracted from a female Xenopus laevis by a conventional method, and oocytes are isolated from the ovary by an enzymic treatment or the like. Oocytes not suitable for experiments are removed by a microscopic observation of their appearances such as size, shape, color and pattern. From the remaining group of oocytes, several cells, preferably 3 to 10 cells, more preferably 4 to 7 cells, and most preferably 6 cells are extracted at random. The membrane potential of the extracted oocytes is fixed to a constant voltage, for example, 100 mV to −40 mV or +20 mV to +60 mV, preferably −60 mV by a known method such as two-electrode voltage clamp method or patch clamp method (See, e.g., Shin pacchikuranpu jikkengijutuhou, ed. Okada Yasunobu, Yoshiokashoten, Joron Ion Chaneru, pp. 1-14). By fixing the membrane potential, it is possible to measure the ionic current passing through channels or transporters of electrically resistant nature. In addition, when the detection of activity of chloride channel is desired for response of GPCR as in the case of the present invention, the event may be detected with high sensitivity by measuring at the potential where the chloride channel becomes most active because many ion channels show a dependence on membrane potential.

To the oocyte after fixing to a certain potential was added about 1 pM to 10 μM, preferably 100 pM to 100 nM, and most preferably 10 nM of LPA, followed by measurement of current response of the oocyte. An average current response is determined for a group of oocytes measured where the current response to LPA stimulation is the difference between the peak current value before LPA addition and the peak current value after LPA addition, providing the response of GPCR for a group of oocytes containing a brood of oocytes. A group of oocytes having a response of GPCR higher than a certain desirable value or within a certain desirable range are selected. The oocytes belonging to the group of oocytes selected in this way originate from a mother, and therefore, each oocyte has genetically nearly equal response of GPCR and may be considered excellent in response of GPCR.

The above procedures are conducted for groups of oocytes extracted from a plurality of mother bodies, and response of GPCR is determined for each group of oocytes. By selecting groups of oocytes showing higher response of GPCR compared with those of other groups, groups of oocytes relatively good in response of GPCR may be selected. Alternatively, response of GPCR that is appropriate for a projected experiment is predetermined empirically using the selected oocytes, and a group of oocytes having a desirable response or a response higher than a certain level or within a certain level are selected by measuring the response to LPA under the same conditions, thereby making it possible to select a group of oocytes having response of GPCR suitable for the projected experiment.

The oocytes belonging to a group of oocytes selected in this way of selection are used in screening for agonists or antagonists of GPCR.

The following describes the case where an exogenous GPCR is chosen as a target GPCR.

The target GPCR is overexpressed in selected oocytes. This is generally performed by introducing mRNA or cRNA encoding the GPCR into the cells by means of microinjection. The method of microinjection of mRNA or cRNA should be referred to JP-A No. 065241/2002 or JP-A No. 065240/2002. To put it briefly, mRNA or cRNA is filled in, for example, the tip of a pipette for insertion into cells, and the pipette for insertion into cells is allowed to come close to a cell and then inserted into the cell up to a predetermined depth. A fixed volume of mRNA or cRNA solution is discharged by oil pressure or air pressure to inject mRNA or cRNA into the cell.

In screening, membrane potential of the oocytes is fixed, for example, by the two-electrode voltage clamp method and the like, preferably to the same potential as applied in the selection by LPA stimulation or −60 mV. The oocytes are exposed to objective test samples that are candidates for agonists in an adequate buffer, e.g.,96 mM NaCl, 2 mM KCl, 1 mM MgCl₂, 1 mM CaCl₂, 5 mM HEPES, pH 7.5, at an appropriate temperature (preferably 15 to 22 degrees C.). The difference in the current response between before exposure and after exposure is determined. When there is certain difference, the test compound is identified as an agonist of the GPCR. The criterion for this judgment is set by a certain fixed level of response of the GPCR using the response to LPA (i.e., the difference in the current responses between before LPA stimulation and after LPA stimulation) as the measure or the difference in the current responses between before and after the oocytes are exposed to the ligand known to the GPCR, and only those test compounds that yield a difference in the current responses higher than the predetermined level may be identified as an agonist of the GPCR. It is also possible to perform screening for antagonists of the GPCR by exposing objective test compounds, which are candidates for antagonists, to the oocytes in the presence of the ligand or an agonist of the GPCR, followed by the measurement of the difference in the current responses before and after the exposure. If the difference in the current responses is smaller than that when the ligand or the agonist alone was exposed to the oocytes (including the case where no current difference was observed), the test compound can be identified as an antagonist of the GPCR.

Further, oocytes having a response of GPCR adequate for a projected experiment may be selected by allowing the oocytes to overexpress the desired GPCR and then measuring their response to LPA.

In this instance, an ovary is extracted from female Xenopus laevis, and oocytes are isolated from the ovary by an enzymic treatment or the like as described above. Oocytes not suitable for experiments are removed by a microscopic observation of their appearances such as size, shape, color and pattern. The remaining oocytes receive microinjection of mRNA or cRNA of a target GPCR and are cultured for a certain time period. After the culture, several oocytes (preferably 4 to 10 cells) are randomly extracted from each batch prepared in parallel and their current responses to LPA stimulation are measured as above, selecting groups of oocytes having responses of GPCR adequate for the projected experiment.

The oocytes selected in this way may be used in screening for ligands, agonists, or antagonists of the GPCR and the like as described above.

When mRNA or cRNA encoding a target GPCR (for example, histamine receptor) is introduced into the oocytes selected by the above method according to a known means of microinjection, the receptor is expressed in the oocytes within 24 hours after the microinjection. The membrane potential of the oocyte presumably expressing the receptor 24 or more hours later from the microinjection is fixed to e.g. −60 mV by the two-electrode voltage clamp method. When a sample containing a ligand of the receptor (e.g., 1 μM histamine) is added to the oocyte, the ligand in the sample and the receptor interact to activate the signal transduction within the oocyte and to generate an ionic current, demonstrating an electric response of the oocyte to the ligand. Therefore, it is possible to detect the presence of a ligand in a sample and an agonist or antagonist activity in a sample on the basis of the cellular response as an indicator, thus allowing screening for ligands, agonists, and antagonists.

In the above method for screening of agonists or antagonists, a group of oocytes adequate for the screening are selected based on the result of the response of G protein-coupled receptor prior to the screening according to the present invention, and therefore, the screening may be conducted in a uniform system in which there is little individual difference among the oocyte population, reducing the probability of giving false positive or false negative results. Thus, the screening method according to the present invention is advantageous in view of high data reliability as well as time efficiency, labor, and cost for screening experiments.

The above method for screening of agonists or antagonists may be applied to screening for agonists or antagonists of any substances as long as they serve as a ligand to G protein-coupled receptor. Further, the above method for screening of agonists may be applied to screening of compounds that serve as the ligand for a G protein-coupled receptor-type orphan receptor whose ligand is not known by means of injecting the nucleotides encoding the orphan receptor into the oocytes. Furthermore, the screening method according to the present invention may be applied to screening of substances related to various intracellular signaling via any G protein-coupled receptors by making appropriate modifications and/or improvements readily conceivable to one of ordinary skill in the art.

### EXAMPLES

### Example 1

Ovaries were extracted from mother bodies A, B, and C, and their follicle cells were removed by a conventional method. The oocytes after removal of follicles were selected based on their appearances that seemed suitable for experiments, and groups of oocytes were saved separately for each mother body (batches A, B, and C). From each batch, six oocytes were extracted at random, respectively.

The membrane potential of each cell was fixed to −60 mV by the two-electrode voltage clamp method. Each cell was stimulated by 1 nM LPA, and then the current response was measured. The difference between the current value before LPA stimulation and the peak current value after LPA stimulation was determined for each cell and shown in Table 1. There were differences in the responses to LPA among the batches.

Each batch of oocytes received microinjection of cRNA of a GPCR according to a conventional method. After the injection, the oocytes were cultured for two days at 18 degrees C. to allow expression of the GPCR. Then, six oocytes were randomly extracted from each batch, respectively.

The membrane potential of each cell was fixed to −60 mV by the two-electrode voltage clamp method. Each cell was stimulated by a ligand of the GPCR, and then its current response was measured. The difference between the current value before stimulation by the ligand and the peak current value after stimulation by the ligand was determined for each cell and shown in Table 1. There were differences in the responses among the batches. These differences in this response were found to be correlated to those in the response to LPA.

It should be noted that an average value was determined here for six oocytes extracted from each batch, while the average value may be determined by excluding both maximum and minimum values of the current responses when oocytes unsuitable for experiments may possibly be contained.

TABLE 1

| | Response to LPA (μA) | | Response of GPCR (μA) | |
|---|---|---|---|---|
| Batch A | Cell (1) | 1.1 | Cell 1 | 0.5 |
| | Cell (2) | 1.5 | Cell 2 | 0.3 |
| | Cell (3) | 0.6 | Cell 3 | 0.8 |
| | Cell (4) | 0.3 | Cell 4 | 0.4 |
| | Cell (5) | 0.8 | Cell 5 | 0.6 |
| | Cell (6) | 0.6 | Cell 6 | 0.4 |
| | Average | 0.8 | Average | 0.5 |
| Batch B | Cell (1) | 2.5 | Cell 1 | 1.0 |
| | Cell (2) | 1.8 | Cell 2 | 1.5 |
| | Cell (3) | 2.6 | Cell 3 | 1.7 |
| | Cell (4) | 1.1 | Cell 4 | 0.9 |
| | Cell (5) | 2.3 | Cell 5 | 0.8 |
| | Cell (6) | 1.4 | Cell 6 | 1.1 |
| | Average | 2.0 | Average | 1.2 |
| Batch C | Cell (1) | 0.1 | Cell 1 | 0.1 |
| | Cell (2) | 0.3 | Cell 2 | 0.2 |
| | Cell (3) | 0.1 | Cell 3 | 0.0 |
| | Cell (4) | 0.4 | Cell 4 | 0.0 |
| | Cell (5) | 0.0 | Cell 5 | 0.1 |
| | Cell (6) | 0.2 | Cell 6 | 0.1 |
| | Average | 0.2 | Average | 0.1 |

### Example 2

The following screening was carried out using a group of oocytes that showed an intense response to LPA in the above example. Since a group of oocytes in batch B were found to be higher in the responses as shown in Table 1, the group of oocytes in batch B were used. The oocytes stimulated by LPA were treated as spent, and an experiment was conducted with the oocytes that had not been stimulated by LPA in batch B.

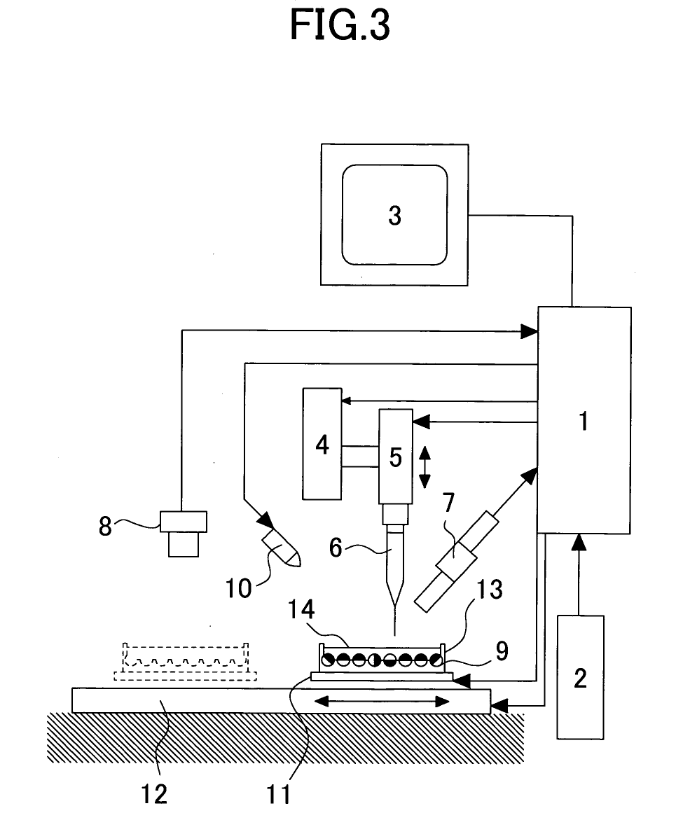

The histamine receptor gene was microinjected into oocytes of the group of oocytes by a conventional method, and 24 hours later, the membrane potential of the cells was fixed to −60 mV by the two-electrode voltage clamp method. The cells were contacted with a buffer (96 mM NaCl, 2 mM KCl, 1 mM MgCl₂, 1 mM CaCl₂, 5 mM HEPES, pH 7.5) containing 1 μM concentration of histamine or the buffer not containing histamine, and their current responses were measured. The microinjection was carried out using the apparatus and method described in Patent Literature 1 (see FIG. 3).

The principle of this apparatus is illustrated in FIG. 3. A tray to arrange the oocytes may be the one having a total of 96 wells with 12 wells in the horizontal direction and 8 wells in the orthogonal direction, each of which is made in uniform depth and shape. The number of wells is not necessarily limited to 96. Amphibian oocytes are generally heavier in the white vegetal hemisphere than in the black animal hemisphere. By making the diameter of the well of the tray slightly larger than that of the oocytes, an average of 80% of the oocytes arranged on the tray are retained in such a way that the black hemisphere is upward without changing their orientation by rotation and the like, which makes it possible to increase the probability of sample injection into the same sphere without using any special means. It is preferred that the shape of the wells to arrange the oocytes is cylindrical, that is, the bottom is a circular plane and the cross sectional shapes parallel to the bottom plane are uniform from the bottom to the opening, or conical at the bottom. The diameter of the opening of the well must be larger than the amphibian oocytes to be used. Based on the fact described above, it is preferred to provide some room for free rotation of the oocytes in the wells that are filled with physiological saline solution and the like, and specifically, the maximum diameter of the well is preferably from 105 to 150% of the diameter of the oocytes to be used. Since the diameter of Xenopus laevis oocytes is about 1.3 mm, setting the diameter of the well to 1.4 to 2 mm allows orientation of the cells to be specifically fixed without injuring them. An example of the well shape suitable for the present example is a mortar-like shape with an angle of 90 degrees at the bottom, a diameter of 1.4 mm, and a depth of 0.56 mm for the cylindrical portion. Besides the use of the tray, the probability of injecting samples into the same sphere may be further improved by using a dropping pipette. In addition, a specific hemisphere, e.g. the white vegetal hemisphere, may be arranged upward by certain manipulation.

Samples to be injected into the oocytes include genes, dyes, proteins, peptides, drugs, and the like, and are not particularly limited. Although the following example describes an injection of cRNA of histamine receptor into the oocytes, genes used for the injection are not limited to cRNA, and any nucleotides such as DNA, RNA, and synthesized oligonucleotides may be used. The needle to inject a sample is preferably a pipette-like needle, but not particularly limited. A digital camera 8 to acquire information on cells such as oocyte orientation and a CCD camera 7 as a means to acquire visual information on the contact of a micropipet 6 with the surface of the oocyte are exemplified here, while the means needed to obtain these information are not limited to the digital camera 8 and the CCD camera 7. For example, the cell surface may be detected based on the information obtained by sensors attached to the microinjection apparatus to detect changes in pressure, temperature, electricity, humidity, pH, and the like.

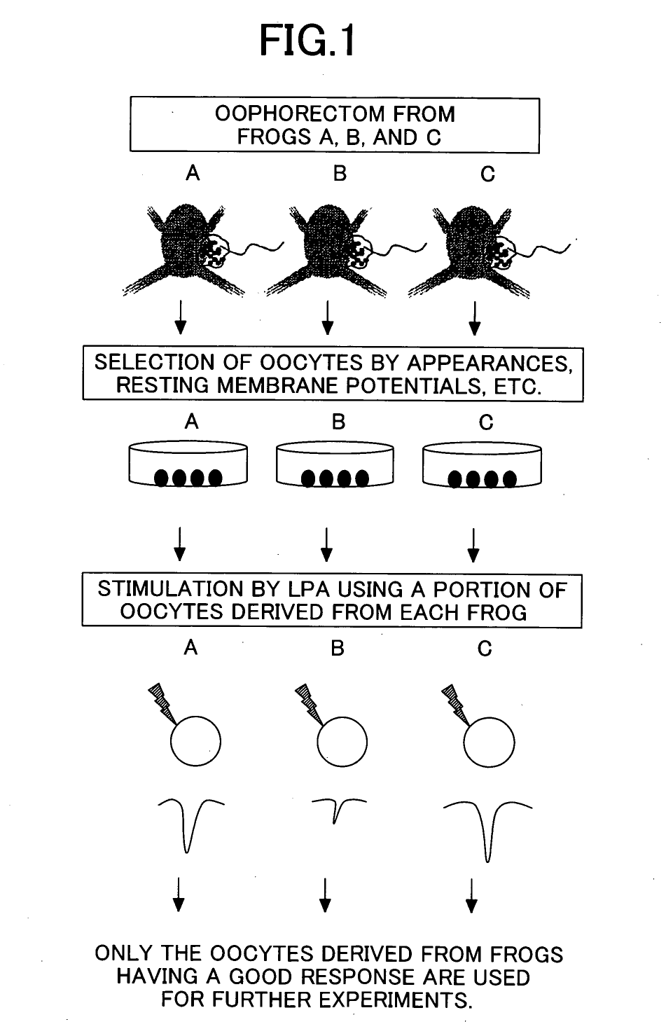

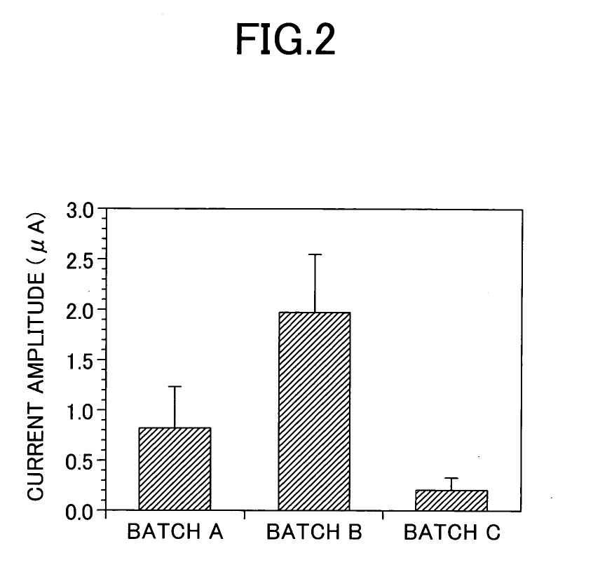

The oocytes before injection of the sample are arranged in the wells of the tray 9, and the tray 9 is filled with a physiological saline solution for amphibians 14, followed by setting on an orthogonal sliding stage 11 and a horizontal sliding stage 12. It is preferred that the position of an oocyte 13 to which a sample should be injected through an injection micropipet 6 is determined by controlling the movements of the orthogonal sliding stage 11 and the horizontal sliding stage 12 to the directions of the x-axis and the y-axis with a controlling unit 1, while a configuration opposite to that in FIG. 1 in which the tray 9 is fixed and the injection micropipet 6 is movably set may be employed.

When the tray 9 is positioned at the place depicted by the broken line, the oocytes may be imaged by the digital camera 8, and the photographic data are sent to the control unit 1, thereby allowing information on the quality of the oocytes and their orientations to be stored.

The horizontal sliding stage 12 and the orthogonal sliding stage 11 are operated by the command of the control unit 1, and the center of a first oocyte 13 that is placed at a predetermined position among the oocytes arranged on the tray 9 is moved toward a lower place of the injection micropipet 6 for microinjection. At this time, a moving slider for injection micropipet 4 is operated to move the injection micropipet 6 along the z axis by the command of the control unit 1, and the tip of the injection micropipet 6 attached to an injection device 5 is moved down to a position slightly distant from the surface of the oocyte, for example, a frontward position several hundreds of millimeters distant. Then, the moving slider for injection micropipet 4 is moved down slowly by directing an auxiliary control unit 2 while observing the image taken by the CCD camera 7 on a monitor 3. The contact of the tip of the injection micropipet 6 with the surface of the oocyte 13 is detected by visual information, pressure change, temperature change, electrical change, humidity change, pH change, and the like, and the moving slider for injection micropipet 4 is stopped at this position. This position serves as the standard point for the subsequent microinjection procedures. After this position is memorized by the control unit 1, and the following procedures are carried out. The moving distance of the injection micropipet from the standard point to the sample injection position and the depth in the direction vertical to the plane where the tray is placed are set, and the injection micropipet 6 is inserted into the cell at the preset depth, followed by discharging a fixed volume of a sample. For the injection of the sample, a control along the z axis such that the injection micropipet 6 is moved down by 0.2 mm from the position where the injection micropipet 6 contacts with the surface of the oocyte 13 may be performed. An optimum depth of the injection micropipet 6 to insert into the cell varies depending on the kind of injection samples and the purpose of the injection, and may be appropriately set. When the injection depth for a sample is too shallow, the sample does not diffuse well within the cell, and when it is too deep, the nucleus or the cell may likely be injured. Therefore, it is desirable in view of expression efficiency that the injection of a sample is carried out at an approximately fixed depth. For instance, when an mRNA is injected into the cytoplasm to express the corresponding protein, it is desirable to insert the micropipet at a depth of 0.02 to 0.1 mm from the cell surface. On the other hand, when a DNA is injected into the nucleus to express the corresponding protein, it is desirable to insert the micropipet at a depth of 0.05 to 0.2 mm from the cell surface. It should be noted that the sample is injected into a place practically shallower than the intended depth because the shape of the oocyte becomes slightly deformed by its contact with the micropipet while inserting. The time for sample injection is controlled by setting the time while the micropipet is being inserted into the cell depending on the volume to be injected into the cell and the like. In addition, a plurality of the injection micropipets 6 may be used to further enhance the efficiency of microinjection. In this case, allowing the relative positions of the injection micropipet and the tray to move in one-dimensional direction or two-dimensional direction may also suffice the driving portion of the apparatus.

Based on the three dimensional positional information about the first oocyte, then the sample is automatically injected into an arbitrary number of oocytes from a second oocyte on the tray 9 at an indicated time period, speed, and injection depth by automatic control. Since there is sometimes variation in the size of oocytes, a function to detect the surface position every time the injection is made may also be provided. Further, the cellular information on the oocytes may be stored in memory of a computer and retrieved when it becomes necessary.

Furthermore, the movements of the injection micropipet 6 and the oocyte 13 while injecting the sample, visual information about the oocytes used for injection and the like are memorized by the computer, and after completing the injection procedures, the sample injection position and depth, characteristics of the cells, and the like may also be set to be read out. In this case, it is desirable that the information on each cell is numbered in reference to each place on the tray.

It is known that amphibian oocytes have the white vegetal hemisphere and the black animal hemisphere, and that each hemisphere has a different function. The present inventors have already found that when an mRNA is injected into the oocytes, the efficiency of functional expression of its protein differs between when the mRNA is injected into the black animal hemisphere of the oocytes and when the mRNA is injected into their white vegetal hemisphere. Thus, in the case of injection of mRNA of histamine receptor, the expression efficiency is higher when injected into the black animal hemisphere, providing oocytes better in response to the ligand, in comparison with when injected into the white vegetal hemisphere. On the other hand, in the case of injection of a chromophore-containing protein, a fluorescent protein, their genes, or a dye, information on their color or light may be obtained with a higher sensitivity when injected into the white vegetal hemisphere. As described above, the use of the tray makes it possible to inject into the black animal hemisphere for approximately 80% of the cells on the tray. When the cells that receive injection of a sample into their specific hemisphere, for example, only into the black animal hemisphere or only into the white vegetal hemisphere, are desired to be obtained, the individual cells are manipulated with a dropping pipette and the like so that the specific hemisphere may be arranged upward in advance of injection of the sample. Alternatively, it is possible to collect the cells in which the sample was injected into the target hemisphere arranged upward based on the positional information about the sample injection on the cell surface that is obtained by a means to acquire visual information or by a sensor to judge black and white colors. In this way, the oocytes having practically the same condition for the injection position may be obtained.

The use of the apparatus configured as above allows a sample to be injected into the amphibian oocytes at a predetermined place and depth, and a large number of the oocytes having approximately the same efficiency of functional expression of the injected sample (efficiency of microinjection) may promptly be produced.

The use of said apparatus may improve the efficiency of microinjection of a sample. That is, it takes about 30 min for a beginner inexperienced in manual microinjection to inject a sample manually into 25 cells, and the efficiency of the injection is about 30% in terms of expression rate of a gene sample. On the other hand, it takes only 3 min to inject the sample into 25 cells with the use of the apparatus, and the efficiency of injection reaches to about 80%. In the case of an expert in manual operation of sample injection, the time required for the injection is not shortened so much, while the efficiency of injection, e.g. 80% manually, may be further improved to 90% by using the apparatus.

Hereinafter, screening of agents acting as an agonist of histamine is exemplified using the histamine receptor gene as an example of the sample to be injected into the oocytes selected according to the present invention.

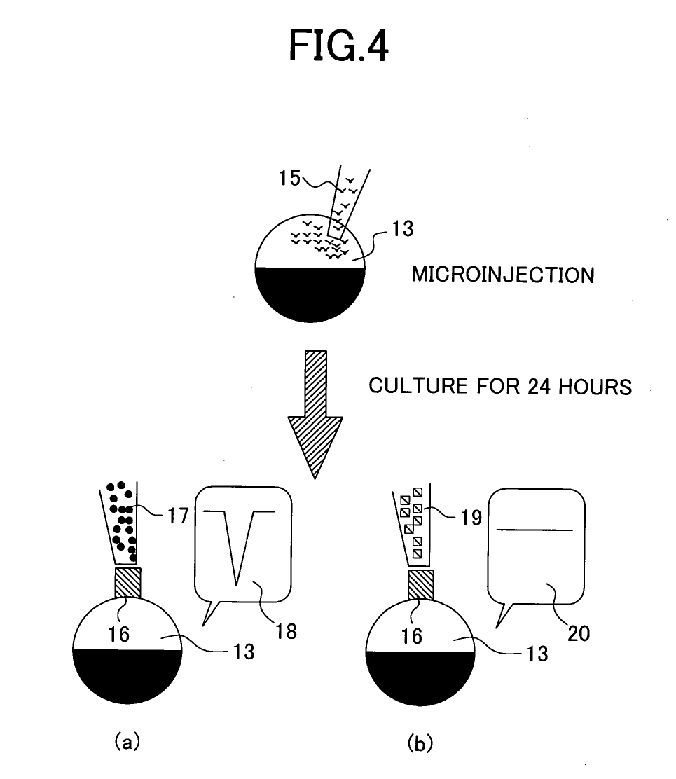

The human histamine receptor gene 15 was microinjected into the oocytes 13 by using the above method, and the injected cells were recovered. It would be readily understood by one of ordinary skill in the art that such injection is not limited to the above method. The oocytes 13 were put in appropriate conditions (e.g., in 96 mM NaCl, 2 mM KCl, 1 mM MgCl₂, 1 mM CaCl₂, 5 mM HEPES buffer (pH 7.5)), and the membrane potential of the cells 13 expressing the human histamine receptor protein 16 twenty-four hours after the microinjection was fixed to −60 mV by the two-electrode voltage clamp method. A plurality of candidate compounds of histamine agonists 17 were added to the buffer at an appropriate final concentration (e.g., 100 μM), respectively. The concentration of the candidate compound may be determined appropriately by the experimenter, and a series of diluted samples may be prepared to have an approximate concentration range of from 0.1 to 100 fold and used instead. The difference in current responses of the cells between before and after the addition of the compound was detected. When the added compound was an agonist of histamine 17, a current response signal was detected 18 (FIG. 4A), while the added compound was not an agonist of histamine 19, a current response was not detected 20 (FIG. 4B). In this way, agents acting as a histamine agonist could be screened based on the current responses induced by them.

Next, screening of agents acting as an antagonist of histamine is exemplified by injecting the histamine receptor gene into the oocytes selected according to the present invention.

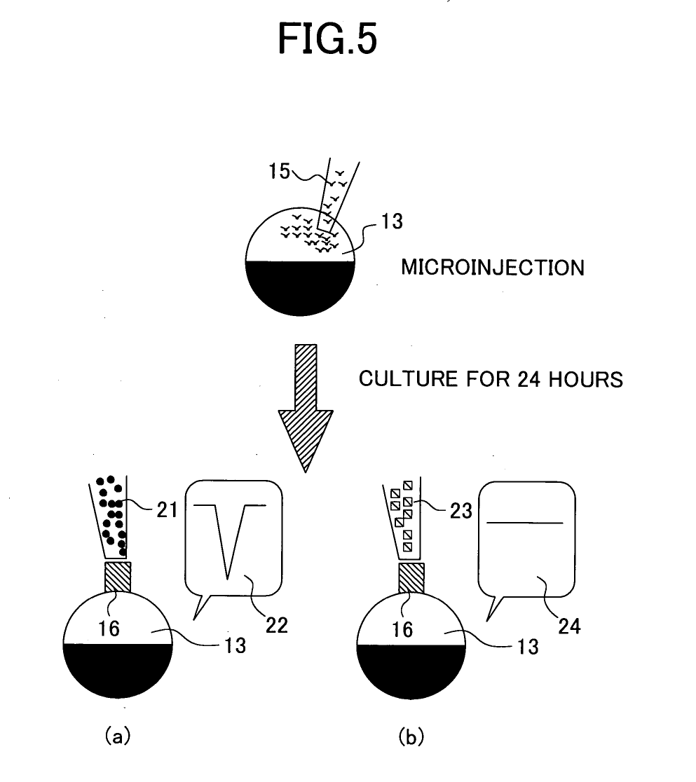

In the same way as above, the membrane potential of the oocytes to which the histamine receptor gene was injected was fixed. A candidate compound of histamine antagonist was added to the buffer at an appropriate final concentration (e.g., 100 μM) in the presence of histamine (e.g., final concentration of 1 μM). The concentration of the candidate compound may be determined appropriately by the experimenter, and a series of diluted samples may be prepared to have an approximate range of from 0.1 to 10 fold and used instead. The difference in current responses of the cells between before and after the addition of the compound was detected. When the added compound was an antagonist of histamine 23, a current response signal was smaller compared with when only histamine was added, or no signal was detected 24 (FIG. 5B), while the added compound was not an antagonist of histamine 21, a current response signal comparable to that when only histamine was added was detected 22 (FIG. 5A). In this way, agents acting as a histamine antagonist could be screened based on the current responses induced by them.

1. A method for selecting oocytes comprising steps of:
preparing groups of oocytes extracted from a plurality of mother bodies and sorted into groups based on the mother body;
determining current responses of G protein-coupled receptor (GPCR) for each group of oocytes in which a portion of each group of oocytes are stimulated individually by lysophosphatidic acid (LPA) and the current responses to LPA are measured; and
selecting groups of oocytes on the basis of the current responses.

2. The method for selecting oocytes according to claim 1, wherein the current response is determined by the difference between a current peak value before LPA stimulation and a current peak value after LPA stimulation.

3. The method for selecting oocytes according to claim 1, wherein the current responses are measured for a plurality of oocytes from each group of oocytes as in claim 1; the measurement is carried out by obtaining the difference between the current peak value before LPA stimulation and the current peak value after LPA stimulation; and the response of GPCR is determined as an average value of the differences for each group of oocytes.

4. The method for selecting oocytes according to claim 3, wherein groups of oocytes that show the average value not lower than 0.5 μA are selected.

5. The method for selecting oocytes according to claim 3, wherein groups of oocytes that show the average value not lower than 0.5 μA and not higher than 3.0 μA are selected.

6. The method for selecting oocytes according to claim 3, wherein a group of oocytes that show the average value higher than the average values for groups of oocytes from other mother bodies are selected.

7. A method for detecting the response of GPCR comprising:
selecting oocytes by preparing groups of oocytes extracted from a plurality of mother bodies and sorted into groups based on the mother body; determining current responses of G protein-coupled receptor (GPCR) for each group of oocytes in which a portion of each group of oocytes are stimulated individually by lysophosphatidic acid (LPA) and the current responses to LPA are measured: and selectin groups of oocytes on the basis of the current responses; and
using the selected oocytes to detect the response.

8. The method for detecting the response of GPCR according to claim 7, wherein one or more kinds of GPCRs are overexpressed in the selected oocytes.

9. The method for selecting oocytes according to claim 1, wherein the portion of each group of oocytes are pre-selected based on visual observation or static membrane potential in advance of LPA stimulation.

10. Groups of oocytes selected based on the responses of GPCR that are determined for a portion of each group of oocytes.

11. The groups of oocytes selected according to claim 10, wherein the current responses are measured for a plurality of oocytes from each group of oocytes as in claim 1; the measurement is carried out by obtaining the difference between the current peak value before LPA stimulation and the current peak value after LPA stimulation; the response of GPCR is determined as an average value of the differences for each group of oocytes; and the groups of oocytes having the average value not lower than 0.5 μA are selected.

12. A method for screening of compounds comprising steps of: preparing groups of oocytes selected on the basis of the responses of GPCR that are determined for each group of oocytes by measuring the current responses to LPA stimulation for a portion of each group of oocytes;
injecting a sample into oocytes belonging to one of the selected groups of oocytes;
contacting a plurality of compounds respectively with the oocytes that received injection of the sample; and
measuring current responses induced by the contact with the compounds.

13. The method for screening of compounds according to claim 12, wherein the compounds are the ones that exert an influence on the signal transduction via GPCR.

14. The method for screening of compounds according to claim 12, wherein the sample represents nucleotides and the oocytes that received injection of the nucleotides express a protein encoded by the nucleotides.

15. The method for screening of compounds according to claim 14, wherein the protein encoded by the nucleotides is a kind of GPCRs and screening is conducted for an agonist or an antagonist of the GPCR.

16. The method for screening of compounds according to claim 12, wherein the step of preparing the groups of oocytes comprises measuring the current responses to LPA stimulation for a portion of each group of oocytes; determining the response of GPCR for each group of oocytes from the measurements; and selecting the groups of oocytes on the basis of the response of GPCR.
